(19) United States
(12) Patent Application Publication
(10) Pub. No.: US 2025/0024231 A1
(43) Pub. Date: Jan. 16, 2025

(54) COMMUNICATING WITH A LARGE NUMBER OF AMBIENT POWER (AMP) DEVICES IN A WIRELESS NETWORK

(71) Applicant: Cypress Semiconductor Corporation, San Jose, CA (US)

(72) Inventor: Rakesh Taori, McKinney, TX (US)

(73) Assignee: Cypress Semiconductor Corporation, San Jose, CA (US)

(21) Appl. No.: 18/511,863

(22) Filed: Nov. 16, 2023

Related U.S. Application Data
(60) Provisional application No. 63/512,837, filed on Jul. 10, 2023.

(51) Int. Cl. H04W 4/38

(52) U.S. Cl. CPC H04W 4/38; H02J 50/001

(57) ABSTRACT

A system includes an array of antennas that are controllable to generate a directed beam of radio frequency (RF) radiation and an anchor wireless device coupled to the array of antennas. The anchor wireless device transmits, via the array of antennas, a first wireless signal as a first directed beam at a first azimuth towards first identification (ID) tags. The first ID tags are ambient power (AMP) devices that harvests environmental energy. The first wireless signal includes a data packet requesting information. The anchor wireless device further receives, via the array of antennas, second wireless signals from the ID tags, each second wireless signal including a second data packet responding with the requested information for a corresponding ID tag of the ID tags.

### CLAIM OF PRIORITY

The present application claims the benefit under 35 U.S.C. § 119(e) of U.S. Provisional Patent Application No. 63/512,837, filed Jul. 10, 2023, which is incorporated by this reference herein.

### TECHNICAL FIELD

This disclosure relates to wireless devices and, more specifically, to communicating with a large number of ambient power (AMP) devices in a wireless network.

### BACKGROUND

Radio frequency (RF) wireless devices have grown in type and capability. In some wireless local area networks (WLANs), anchor wireless devices such as routers and access points (APs) can be configured to track a location and optionally also a status of numerous client wireless devices that travel throughout a geographic area of the WLAN. Client wireless devices, such as wireless identification tags, are therefore duplicated throughout tracking systems. Some use cases include tagging containers of retail products traveling from and between warehouses and tagging luggage being transported from and between air transportation and within airports.

Employing ambient power (AMP) devices, which harvest energy from the environment, for tagging purposes may be cost-effective, but may cause reliability issues due to operating with low and unpredictable amount of power. For example, AMP devices in a high-density concentration may be difficult to read due to limits on how many responses an anchor wireless device can receive when requesting data such as identification and status. The limits may be due to at least an amount of incoming data streams that may be concurrently resolved. Other limits include, for example, the number of AMP devices that can be attached to an anchor wireless device at any given time, the number of responses a given anchor wireless device can handle, and the number of responses that can be scheduled in a given time period without blocking access to a channel by other devices, potentially with latency-sensitive traffic.

### BRIEF DESCRIPTION OF THE DRAWINGS

FIG. 1A is a block diagram of an exemplary wireless network configured with RF band arrangements for downlink and uplink transmissions between an anchor wireless device and an AMP device according to various embodiments.

FIG. 1B is a block diagram of an exemplary wireless network configured with RF band arrangements for downlink and uplink transmissions between an anchor wireless device and an AMP device according to other embodiments.

FIG. 2 is a flow diagram of a method of configuring the wireless network to communicate over different RF bands (or at least different frequencies within the same RF band) as between downlink and uplink transmissions, respectively, according to an embodiment.

FIG. 3 is a block diagram of an exemplary wireless network or system that employs one or more anchor wireless devices configured for beamforming according to at least one embodiment.

FIG. 4 is a block diagram of an exemplary anchor wireless device configured for beamforming in vertical and azimuthal directions according to some embodiments.

FIG. 5A is a flow diagram of a method of employing beamforming by an anchor wireless device to communicate with a subset of AMP devices according to at least one embodiment of a high-density concentration of AMP devices.

FIG. 5B is a flow diagram of a method of scanning, using beamforming, at different azimuth ranges to communicate with multiple subsets of AMP device according to at least another embodiment of a high-density concentration of AMP devices.

FIG. 6 is a flow diagram of a method of employing beamforming concurrently by two anchor wireless devices to more efficiently scan a larger area of a high-density concentration of AMP devices according to some embodiments.

FIG. 7 is a simplified block diagram of an example wireless device, which may represent any of the anchor or client wireless devices discussed herein according to various embodiments.

### DETAILED DESCRIPTION

The following description sets forth numerous specific details such as examples of specific systems, devices, components, methods, and so forth, to provide a good understanding of various embodiments of communicating with a large number of ambient power (AMP) devices in a wireless network. Some wireless devices AMP devices, e.g., AMP wireless clients, are simple wireless devices needing little processing and memory, and thus can operate with little power. These AMP devices harvest (or scavenge) energy out of the environment sufficient for brief and reduced processing. For example, AMP devices may communicate an identifier (ID) and/or other data being gathered by anchor wireless devices, such as routers and APs, from the AMP devices. Anchor wireless devices, which are stationary, may be so referenced within mesh networks because locations of anchor wireless devices are known, and thus are similarly referenced herein to be distinguished from mobile client wireless devices, such as AMP-based devices. In some cases, the known location is relative to a moving vehicle or the like, as some anchor wireless devices may have some level of mobility.

As discussed previously, employing AMP devices as wireless identifications tags (or similar AMP wireless clients) within a WLAN tracking system is difficult due to having to operate the AMP devices at low power. Further, typical communication between an anchor wireless device and a mobile client wireless device (e.g., in the WLAN tracking system) occurs over the same RF band and often at the same frequency, which may be nonoptimal for networked communication between downlink (DL) communication to the AMP devices and the uplink (UL) communication from the AMP devices. Despite these challenges, AMP devices may be desired due to the cost-effective deployment of a large number of client wireless devices in the WLAN tracking system, e.g., for tagging and tracking numerous containers, crates, products, and other assets that will be discussed by way of example.

Further, the high-density concentration of AMP devices in any given area (e.g., a common geographical area) from hundreds to thousands of passive tags, creates challenges in being able to read data wirelessly from all of the AMP devices. For example, an anchor wireless device has to individually communicate with unique addresses (e.g., medium access control (MAC) addresses) of respective AMP devices and has bandwidth limits in terms of how much data can be received and separately processed. Further, there is a practical limit in terms of how many AMP devices may be energized at a time so that the AMP devices that are transmitting data have sufficient power to do so.

To resolve these and other deficiencies with known approaches to employing AMP devices in WLAN-based systems, the present disclosure configures anchor wireless devices in varying embodiments of beamforming to communicate with only a subset of AMP devices at a time, thus overcoming these deficiencies and obstacles. For example, the anchor wireless devices may generate directed beams of arbitrary narrowness to target any given subset of the AMP devices depending on the context or application of using the AMP devices to tag different products or assets. In some embodiments, the anchor wireless devices are configured to scan through multiple different azimuths, e.g., a particular azimuth range at a time (such as somewhere between 5-35 degrees at a time) before moving to the next or subsequent azimuth range. In related embodiments, the anchor wireless devices are configured to scan over azimuth ranges and also concurrently scan over distances in a vertical direction to target horizontal slices of a directed beam.

For example, in at least some embodiments, a system includes an array of antennas that are controllable to generate a directed beam of radio frequency (RF) radiation. The system may further include an anchor wireless device coupled to the array of antennas. In various embodiments, the anchor wireless device transmits, via the array of antennas, a first wireless signal as a first directed beam at a first azimuth towards a first plurality of identification (ID) tags. In some embodiments, the first plurality of ID tags are ambient power (AMP) devices that harvest environmental energy, and the first wireless signal includes a data packet requesting information. Further, the plurality of ID tags may be a subset of a larger number of ID tags commonly located, e.g., in an airport, warehouse, or other holding area.

In some embodiments, the anchor wireless device further receives, via the array of antennas, second wireless signals from the plurality of ID tags, each second wireless signal including a second data packet responding with the requested information for a corresponding ID tag of the plurality of ID tags. Once the second data packets are processed, the anchor wireless device scans to another azimuth (or azimuth range) and/or optionally to another vertical distance before repeating the process to communicate with a second plurality of ID tags that are also AMP devices, e.g., a second subset of the large number of ID tags.

In further or additional embodiments, this disclosure sets forth configuring and/or operating the anchor wireless devices and the AMP devices such that the AMP devices are energized for the purpose of communicating a limited amount of data transmitted by the AMP devices to the anchor wireless devices. The present disclosure discusses embodiments of arranging communication between the anchor wireless devices and the AMP devices (or AMP wireless clients) in which the AMP devices are energized in different ways, power consumption by the AMP devices is minimized, e.g., via minimizing channel contention requirements, and the RF bands are configured such that uplink (UL) transmissions can differ in RF band (or at least in frequency) from downlink (DL) transmissions.

In at least one embodiment, a wireless network includes an anchor wireless device to transmit, over a first radio frequency (RF) band, a first wireless signal including a data packet requesting information. Each client wireless devices (e.g., AMP device) may be configured to harvest environmental energy, receive the first wireless signal, and parse the data packet. In these embodiments, each client wireless device transmits, over a second RF band, a second wireless signal to the anchor wireless device, where the second wireless signal includes a data packet responding with the requested information. In some embodiments, the second RF band operates at a lower frequency range than that of the first RF band. In other embodiments, the first RF band is the same as the second RF band, but the DL transmission and the UL transmission are over different frequencies with significant separation within that RF band. In other embodiments, the second RF band operates at a high frequency range than that of the first RF band, which may provide a wider bandwidth and thus also have separate power consumption benefits.

The present disclosure includes a number of advantages, including the facilitation of anchor wireless devices within a WLAN tracking system communicating with a high-density concentration of AMP devices despite technical obstacles that would otherwise be present. For example, despite addressing, bandwidth, and energizing limitations associated with communicating with a high-density concentration of AMP devices, the present disclosure explains the use of various beamforming embodiments that overcome these technical challenges. Further advantages include the ability to minimize power consumption by AMP devices employed as wireless client devices within a WLAN tracking system, providing different possible ways to energize the AMP devices, and different ways in which the DL and UL transmissions can be arranged to minimize RF band and/or frequency conflicts. Additional advantages will be apparent to those skilled in the art of WLAN-related tracking systems that employ AMP devices.

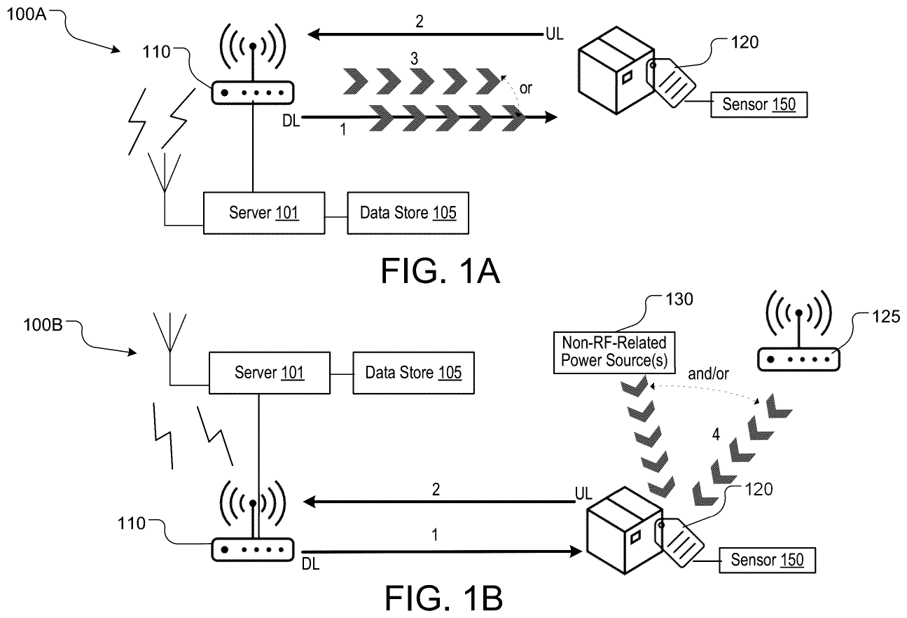

FIG. 1A is a block diagram of an exemplary wireless network 100A configured with RF band arrangements for downlink (DL) and uplink (UL) transmissions between an anchor wireless device 110 and an AMP device 120, e.g., client wireless device, according to various embodiments. In some embodiments, the anchor wireless device 110 is an access point, a router, a wireless hub, a mobile hotspot device, or a wireless (or cellular) base station or the like that is stationary. In various embodiments, the AMP device 120 is a wireless identification tag or low-power client wireless device or AMP station (STA).

In some embodiments, the anchor wireless device 110 communicates to a WLAN server 101 to upload data to a cloud. In these embodiments, the WLAN server 101 includes or is coupled to a data store 105 of volatile or non-volatile memory, e.g., within cloud-based storage. In this way, data or information collected by the anchor wireless device 110 can be stored, by the WLAN server 101, in the data store 105 where the data can optionally be indexed against respective AMP devices (including the AMP device 120), e.g., in a database or the like. In various embodiments, the data or information collected and stored includes an identification and/or a location of the AMP device 120, temperature data, humidity data, pressure data, level data (e.g., level of fluid or gas within a container) and/or other data associated with an environment of the AMP device 120. In some embodiments, the data or information is a log or array of information to include a data history of the AMP device 120 that includes environmental data or information collected over time. The sensor-related data may be detected from a sensor 150 (or multiple sensors) included within or coupled to the AMP device 120.

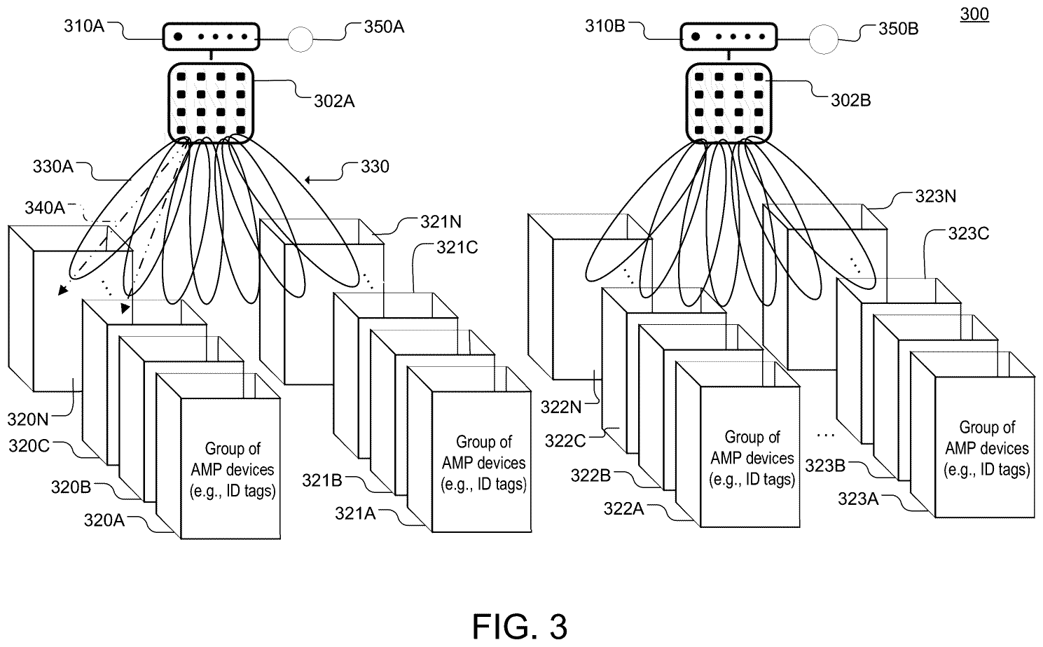

In many embodiments, as will be discussed starting with reference to FIG. 3, there are one or more anchor wireless devices and many client wireless devices, which are AMP devices, as disclosed herein. Ambient power (AMP) devices are energized by harvesting energy from RF signals (e.g., RF-related power sources) and/or from non-RF-related power sources. In various embodiments, harvested energy from RF-related power sources are from in-band RF power sources (e.g., within the same RF band being used for DL/UL transmissions) or out-of-band RF power sources (e.g., DL and UL transmissions take place in different RF bands compared to RF band being used for energy harvesting). In additional embodiments, as will be illustrated with reference to FIG. 1B, non-RF-related power sources include solar or photovoltaic cells (convert ambient sunlight into electricity), thermoelectric generators (convert temperature gradients into electricity), vibration energy harvesting using piezoelectric, electrostatic, and electromagnetic converters (convert mechanical vibrations from the environment into electricity), miniature wind turbines (convert ambient wind energy into electrical power), pressure differential energy harvesting, dynamos or wearable harvesters (convert human or animal motion into electrical energy), and other such energy-harvesting mechanisms.

With additional reference to FIG. 1A, in at least one embodiment, the anchor wireless device 110 transmits a first wireless signal (1), which is DL transmission, over a first RF band to the AMP device 120. In some embodiments, the first wireless signal includes a data packet requesting information from the AMP device 120. The AMP device 110 may receive the first wireless signal and parse the data packet to determine the requested information.

In these embodiments, the AMP device 120 transmits a second wireless signal (2), which is an UL transmission, over a second RF band to the anchor wireless device 110 with a data packet with the requested information. In this way, the requested information or data (discussed previously) may be requested and received from the AMP device 120 through data packet exchange. In various embodiments, the anchor wireless device 110 generates the first wireless signal employing technology such as Wi-Fi®, Bluetooth®, Bluetooth® Low Energy, Ultra-Wideband (UWB), Z-wave™, Zigbee®, LoRa™, Wi-SUN®, or other wireless protocol. In various embodiments, the AMP device 120 generates the second wireless signal employing technology such as Wi-Fi®, Bluetooth®, Bluetooth® Low Energy, Ultra-Wideband (UWB), Z-wave™. Zigbee®, LoRa™, Wi-SUN®, or other wireless protocol.

In some embodiments, the first RF band for DL transmission differs from the second RF band used for UL transmission. In some embodiments, the second RF band operates at a lower frequency range than that of the first RF band, e.g., as low frequencies consume less power. Lower frequencies also exhibit smaller path losses compared to higher frequencies and, at the same power, the wireless signals can be adequately received and decoded at a farther distance and propagate through or around obstacles better compared to higher frequencies. Further, RF and circuit design at lower frequencies can be far less complex compared to being designed for higher frequency operation, keeping costs low for the AMP devices.

In other embodiments, the first RF band is the same as the second RF band, but the DL transmission and the UL transmission occur over different frequencies with significant separation, e.g., more than a few 100 megahertz (MHz) within that same RF band. In these ways, both the technology and RF bands (or frequencies) can differ as between the DL/UL transmissions so that AMP devices can operate at lower power while avoiding frequency conflicts between the DL and UL transmissions.

In some embodiments, the second RF band operates at a higher frequency range than that of the first RF band, e.g., higher frequency operations deploy wider channel bandwidths, which in turn allow a transmission of the same number of user bytes to finish earlier. The AMP device 120 may then receive and/or transmit for a shorter period of time, conserving power and providing a separate power consumption benefit. Accordingly, use of a higher frequency range or a lower frequency range with the UL transmission (compared to the DL transmission) may involve a cost-benefit analysis that weighs these benefits as between higher or lower frequency ranges.

In various embodiments, the first wireless signal (1), e.g., transmitted in the first RF band, is also an energizing RF signal, illustrated with thick directional indicators, from which the AMP device 120 harvests energy. In similar embodiments, the anchor wireless device 110 instead transmits a separate energizing RF signal (3) towards the AMP device 120, but this separate energizing RF signal (3) is also within the first RF band, e.g., is not necessarily the same as the first wireless signal (1), but may be close in frequency. In alternative embodiments, the separate energizing RF signal (3) is transmitted over the second RF band, e.g., of the UL transmission, or is transmitted over an entirely different third RF band. Accordingly, in differing embodiments, the energizing RF signal (3) is sent over the first RF band, the second RF band, or the third RF band. For example, in some embodiments, by way of example, the first RF band is 5.0 gigahertz (GHz), the second RF band may be 2.4 GHz, and the third RF band may be 5.0 or 6.0 GHz, where the third RF band may also be employed by the anchor wireless device 110 to communicate with other mobile stations (STA).

FIG. 1B is a block diagram of an exemplary wireless network 100B configured with RF band arrangements for DL and UL transmissions between the anchor wireless device 110 and the AMP device 120 according to other embodiments. In some embodiments, the anchor wireless device 110 does not transmit the energizing RF signal. For example, in other embodiments, the wireless network 100B further includes a second anchor wireless device 125 and/or non-RF-related power sources 130 that will provide RF power and/or non-RF power, respectively, from which the AMP device 120 harvests energy (e.g., from power sources other than from the anchor wireless device 110 associated with the DL/UL transmissions). Possible non-RF-related power sources were previously discussed. In some embodiments, the second anchor wireless device is a cellular base station operating in licensed or shared frequency bands.

TABLE 1

| Energizing AMP STAs | DL Transmissions | UL Transmissions | |
|---|---|---|---|
| (Signal 3 or 4) | (Signal 1) | (Signal 2) | Notes: |
| Band X | Band X | Band X | RF band for energy |
| (e.g., 900 MHz) | (e.g., 900 MHz) | (e.g. 900 MHz) | harvesting same as the RF |
| | | | band used for DL/UL |
| Band X | Band Y | Band Y | RF band for energy |
| (e.g. 900 MHz) | (e.g. 2.4 GHz) | (e.g. 2.4 GHz) | harvesting different from |
| | | | RF band used for DL/UL |
| Band X | Band X | Band Y | DL/UL on different bands; |
| (e.g. 900 MHz) | (e.g. 5 GHz) | (e.g. 900 MHz) | RF band for energizing is |
| | | | same as RF band for DL |
| Band X | Band Y | Band X | DL/UL on different bands; |
| (e.g. 2.4 GHz) | (e.g. 6 GHz) | (e.g. 2.4 GHz) | RF band for energizing is |
| | | | same as RF band for UL |
| Band X | Band Y | Band Z | All 3 bands are different |
| (e.g. 2.4 GHz) | (e.g. 5 GHz) | (e.g. 900 MHz) | |

In at least some embodiments, the second anchor wireless device 125 transmits an energizing RF signal (4) towards the client wireless device from which the client wireless device harvests energy. In various embodiments, the energizing RF signal (4) is transmitted over one of the first RF band, the second RF band, or a third RF band. In some embodiments, the energizing RF signal (4) is transmitted as a continuous wave (CW) or using technology including Bluetooth®, Bluetooth® Low Energy, or Zigbee®. In further embodiments, the energizing signals (1) or (3) discussed with reference to FIG. 1A are combined with the energizing RF signal (4) of FIG. 1B. Further, non-RF-related energy harvesting may be employed alone or in combination with RF-related energy harvesting. Table 1 summarizes the different combinations of RF bands for DL/UL transmissions and energizing RF signals associated with the embodiments explained above with reference to FIGS. 1A-1B. The example frequencies provided after the respective RF bands are by way of example only and are not meant to be limiting, as the different frequencies can vary widely and may depend on different technology and protocols now in existence or yet to be developed. For example, in addition to 900 MHz, 2.4 GHz, 5 GHz, and 6 GHz, millimeter wireless also operates in the 57-71 GHz range and any of the RF bands listed in Table 1 could also be within the millimeter wireless range of operation.

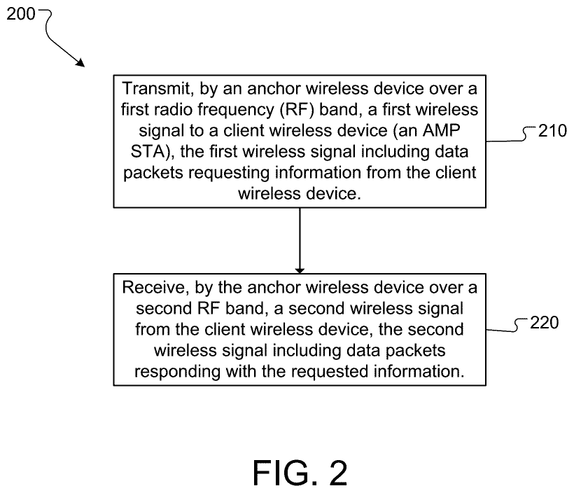

FIG. 2 is a flow diagram of a method 200 of configuring the wireless network 100 to communicate over different RF bands (or at least different frequencies within the same RF band) as between downlink and uplink transmissions, respectively, according to an embodiment. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the anchor wireless device 110, e.g., processing logic of the anchor wireless device 110.

At operation 210, the processing logic transmits, over a first RF band, a first wireless signal to a client wireless device. In some embodiments, the client wireless device is an ambient power (AMP) device that harvests environmental energy. In some embodiments, the first wireless signal includes a data packet requesting information from the client wireless device.

At operation 220, the processing logic receives, over a second RF band, a second wireless signal from the client wireless device. In some embodiments, the second wireless signal includes a data packet responding with the requested information. In various embodiments, the requested information includes an identification of the client wireless device, security credentials, a location of the client wireless device, temperature data, pressure data, and/or environmental-related data associated with the environment of the client wireless device.

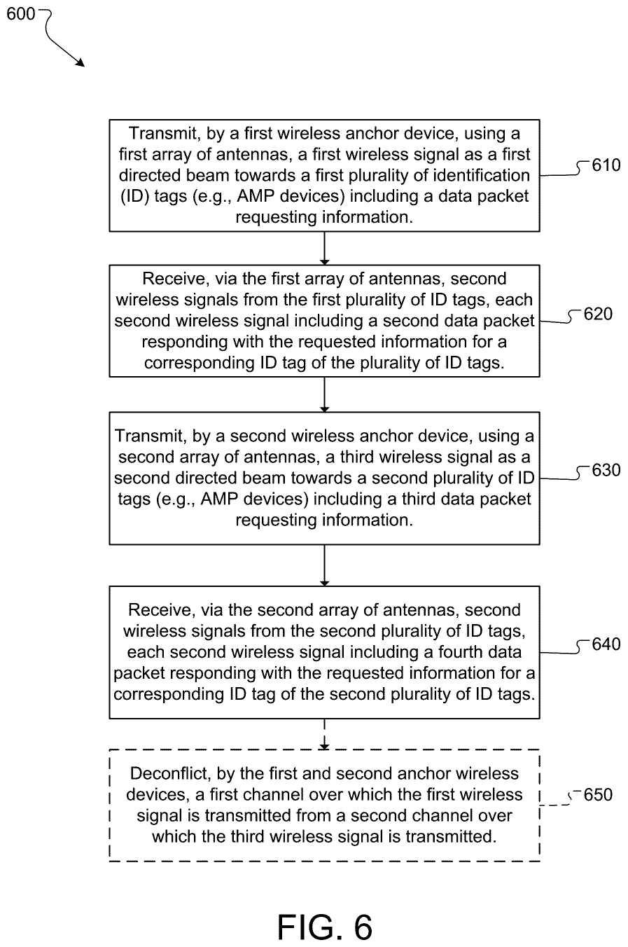

FIG. 3 is a block diagram of an exemplary wireless network 300 (or system) that employs one or more anchor wireless devices configured for beamforming according to at least one embodiment. In some embodiments, the wireless network 300 includes at least a first anchor wireless device 310A coupled to an array of antenna 302A. In further embodiments, the wireless network 300 includes a second anchor wireless device 310B coupled to an array of antennas 302B. Although much of the functionality of the first and second anchor wireless devices 310A and 310B is explained with reference to the first anchor wireless device 310A, the second anchor wireless device 310B functions the same or similarly. Further, as will be explained in more detail, sometimes the first and second anchor wireless devices 310A and 310B coordinate functionality to deconflict frequency or RF band of operation, e.g., to facilitate concurrent operation to be able to identify and communicate with twice as many AMP devices (see FIG. 6).

Additionally, in various embodiments, the wireless network 300 includes many groups or pluralities of AMP devices, generally referred to herein as ID tags, e.g., wireless ID tags, each being identified by an address such as a MAC address. For example, the wireless network 300 may include arrays of groups of ID tags, although not all use cases will have the ID tags so neatly organized, as illustrated. Only by way of example, a first array may include groups of ID tags 320A-320N, a second array may include groups of ID tags 321A-321N, a third array may include groups of ID tags 322A-322N, and a fourth array may include groups of ID tags 323A-323N. Further, in some embodiments, individual ID tags of these groups of ID tags will be mobile, and thus come and go over time. In other embodiments, at least some of the groups of ID tags are being carried on a transportation truck, for example, and thus are all in transit while passing under (or near) the anchor wireless device 310A or 310B, e.g., at an entrance or exit gate, a port of call, or the like.

Although each array of antennas 302A and 302B is illustrated oriented vertically for purposes of illustration, it should be understood that each array of antennas 302A and 302B may also be oriented horizontally, e.g., facing the groups of ID tags. In some embodiments, the first and second anchor wireless devices 310A and 310B are generally located centrally within a room or area or near top corners of such a room or area that contains the groups of ID tags, to radiate directed beams and communicate with as many of the groups of ID tags as possible from a stationary location. Thus, multiple anchor wireless devices may be employed to support larger areas of ID tag movement flow.

In various embodiments, the use cases or applications of the wireless network 300 (or system) may include smart manufacturing (e.g., inventory, asset tracking and positioning, and environment or production line sensing and monitoring), data center (e.g., environmental monitoring, facility monitoring, and asset management), smart home (asset management, home environment monitoring, and home security), logistics and warehouse (e.g., goods tracking and inventory management), fresh food supply chain (route crates or boxes, sense temperature), smart agriculture (monitoring of soil moisture, soil fertility, temperature, wind speed, plant growth, and associated with control of agricultural facilities), healthcare and medical (e.g., tracking supplies, blood, and organs that have critically limited shelf life), indoor positioning (positioning objects in a shopping malls, factories, warehouses, and the like), and smart power grid (sending of sound, heat, pressure, smart meter to achieve awareness of device and equipment statuses).

With particular focus on a flower warehouse, each crate of flowers may include a unique ID tag that is connected to a sensor such as the sensor 150 in the wireless networks 100A and 100B of FIGS. 1A-1B. In some embodiments, the sensor 150 is a thermometer and can track temperature. The unique ID tag for the crate may periodically, in response to the anchor wireless device 310A, transmit temperature data so that the anchor wireless device can track both a location and temperature of the crate of flowers. In this way, flowers that go to different distributors and then on to different grocers can be tracked in terms of exposure: where did the flowers travel and to what temperatures were the flowers exposed during transportation. Florists may want this information to understand the nature of the transport experience and whether the quality of the flowers suffers from certain points of transit. In some applications, there could be an a priori division of a warehouse room into specific areas storing different types of flowers, for example, or a different number of days that the flowers have been in the warehouse (shift from old to new) as ID tags move closer to the entrance or the loading gate.

With particular focus on luggage transportation in connection with airports and associated airport transportation, each piece of luggage may include a unique ID tag that is issued by the airline with which the passenger is flying. In these embodiments, the anchor wireless device 310A receives a response from individual pieces of luggage from various airlines, indicating that the luggage is in range of the anchor wireless device, e.g., which could indicate that the luggage has exited the aircraft, the luggage is in transit to the terminal, or the luggage has when deposited on a particular baggage claim carousel. In this way, the items of luggage can be tracked throughout their journey and users can get updates from the system, e.g., on their mobile device.

With particular focus on medical applications, in some situations, organs to be transplanted are transported in a way that keeps the organs safe and healthy for use in a target patient in need of that organ. In these use cases, medical personnel need to track the temperature, humidity, and progress through certain checkpoints to know the organ remains viable and is progressing on track to be transplantable in a target patient. In other scenarios, certain medicines should be tracked in terms of remaining at viable temperature and do not become outdated for effective use in treatment. These types of use cases may be covered with the disclosed AMP devices in various embodiments.

With particular focus on livestock, in some situations, chickens, cows, or other animals may be tagged in order to track a location. In some use cases, farmers track temperature and/or moisture of an environment where the livestock travel. In such embodiments, the anchor wireless device 310A receives a response from individual tags, one for each animal, to track a location as well as receive sensor-related data associated with an environment of the livestock.

With particular focus on a warehouse for any type of goods, each container or box of products may include a unique ID tag, which is optionally connected to a sensor such as the sensor 150 in the wireless networks 100A and 100B of FIGS. 1A-1B. In these embodiments, the flow of different products for sale may be tracked by the ID tags and any type of environmental data that may be associated with the products may be received via the connected sensors 150. So, for example, the product may be a dry good such as bulk nuts or grains. Each container or box of such dry goods may be tagged with a unique ID tag and be connected to a moisture sensor so that the level of moisture can be tracked during transit and delivery. In this way, a purchaser of the dry goods can be assured the dry goods have not been overexposed to moisture, which may compromise the product. In various embodiments, the anchor wireless device 310A transmits, via the array of antennas 302A, a first wireless signal as a first directed beam 330A at a first azimuth 340A towards a first plurality of identification (ID) tags, e.g., group of ID tags 320N just by way of example. In some embodiments, the first plurality of ID tags are ambient power (AMP) devices that harvest environmental energy and the first wireless signal includes a data packet requesting information.

In these embodiments, the anchor wireless device 310A receives, via the array of antennas 302A, second wireless signals from the plurality of ID tags, each second wireless signal including a second data packet responding with the requested information for a corresponding ID tag of the plurality of ID tags. For example, each ID tag of the plurality of ID tags may receive the first wireless signal, parse the data packet to determine the requested information, and generate a second wireless signal with the second data packet containing the requested information. In some embodiments, each second wireless signal operates at the same or different frequency from the first wireless signal.

In some embodiments, the wireless network 300 (or system) further includes an environmental sensor (e.g., as the sensor 150 of FIGS. 1A-1B) coupled to each of the plurality of ID tags. In these embodiments, the requested information includes an ID of a respective ID tag, temperature data, pressure data, or environmental-related data received from a respective environmental sensor 150 coupled to the respective ID tag, or a combination thereof. In some embodiments, the anchor wireless device 310A is also or alternatively coupled to infrastructure sensor(s) 350A or 350B (e.g., that are always present in a warehouse, a refrigerated van, or the like) and obtain this sort of environmental data from the infrastructure sensor(s) 350A or 350B. In some embodiments, therefore, the ID tags respond with only an ID, indicating the ID tags are present, and other environmental data is gathered from other sources within the wireless network 300. In these embodiments, the anchor wireless device 310A and/or the server 101 combines the environmental data with the ID or presence information to be stored as a log in the data store 105, e.g., where the log may be indexed against a respective ID tag. In some embodiments, an operator can query, via the server 101, the data store 105 to retrieve a particular log or information stored in the data store 105 associated with particular ID tags. In this way, tracked IDs and environmental data may be centrally stored and looked up to determine status or history of the route of a particular ID tag or group of ID tags.

In at least some embodiments, the anchor wireless device 310A transmits, via the array of antennas 302A, a plurality of first wireless signals as different directed beams 330 at a plurality of corresponding azimuth ranges (e.g., different beamwidths), each different directed beam being transmitted during a different scanning period. In this way, communicating with different subsets of ID tags within different zones can be performed separately, while avoiding excessive double-scanning of any given zone. The scanning period can be time-multiplexed, for example, so that the anchor wireless device 310A separately communicates with each plurality (or subset) of ID tags. In various embodiments, each azimuth range may span over 5-35 degrees and step through sufficient directional azimuths to radiate an entire geographic area where ID tags are expected to move. In some embodiments, the anchor wireless device 310A transmits some of the different directed beams 330 at different frequencies or frequency bands, e.g., if the ID tags at some azimuths are expected to receive wireless signals at different frequencies (or frequency bands) compared to other ID tags located along other azimuths.

In some embodiments, the first and second anchor wireless devices 310A and 310B generate directed beams of arbitrary narrowness to target any given subset of the ID tags depending on the context or application of the WLAN tracking system. For example, the narrower the beamwidth, the narrower the covered area, and the fewer ID tags that will be activated and/or engaged in communication. Further, the narrower the beamwidth, the more powerful the link with the ID tags, enhancing communication and ensuring the ability to transmit data to and receive data from the ID tags, despite distance away or motion of the ID tags. In some embodiments, at least the first wireless signals (transmitted by the first and second anchor wireless devices 310A and 310B) are millimeter wave signals (e.g., mmWave signals), which tend to perform better as directed beams due to path loss experienced at millimeter wave frequencies.

According to these embodiments, for each azimuth range of the plurality of corresponding azimuth ranges, the anchor wireless device 310A receives the second wireless signals from the plurality of ID tags located in an area activated by a corresponding directed beam of the different directed beams. The anchor wireless device 310A may further store IDs from data packets received within the second wireless signals. The anchor wireless device 310A may further store environmental data, received within the data packets, associated with corresponding ID tags of the plurality of ID tags. This storage may be performed within the data store 105, which was discussed with reference to FIGS. 1A-1B.

In at least some embodiments, the anchor wireless device 310A further assigns a beam index to each azimuth range of the plurality of corresponding azimuth ranges. In these embodiments, the anchor wireless device 310A further maps, within the data store 105, each of a plurality of geographic zones to a corresponding beam index. In these embodiments, the anchor wireless device 310A further stores, in the data store 105, IDs of each of the plurality of ID tags in association with a mapping between a geographic zone and a beam index. An example of the data store 105 (such as a table or database) based on these operations is reflected in Table 2. Although the azimuth range need not also be stored, as the azimuth ranges may already be known or pre-programmed by the sever 101 as corresponding to the beam index, the azimuth ranges are also illustrated for explanatory purposes. Further, actual azimuth ranges may differ depending on from which axis the azimuth ranges are taken for purposes of tracking, so Table 2 is merely exemplary.

TABLE 2

| | Azimuth Range | | |
|---|---|---|---|
| Tag ID | (in degrees) | Beam Index | Geographic Zone |
| 1 | 51-60 | 3 | 5 |
| 2 | 61-70 | 4 | 5 |
| 3 | 41-50 | 2 | 15 |
| 4 | 71-80 | 5 | 35 |
| . . . | | . . . | . . . |
| N | 141-150 | M | Z |

As an extension of the explanation related to FIGS. 1A-1B, in some embodiments, the first anchor wireless device 310A (or second anchor wireless device 310B) transmits an energizing RF signal towards the plurality of ID tags from which the plurality of ID tags harvest energy or cause the first wireless signal to also be the energizing RF signal. In some embodiments, the first wireless signal or a continuous waveform (CW) is in the first RF band, and each second wireless signal (transmitted by respective ID tags) is within one of the first RF band or a second RF band.

In some embodiments, the energizing RF signal (whether being the same or different from the first wireless signal) is a millimeter wave signal (or mmWave signal). Within the mmWave RF band, 57-71 GHz is unlicensed and thus provides many possible different RF channels over which the first and second anchor wireless devices 310A and 310B can communicate and/or energize the plurality of ID tags.

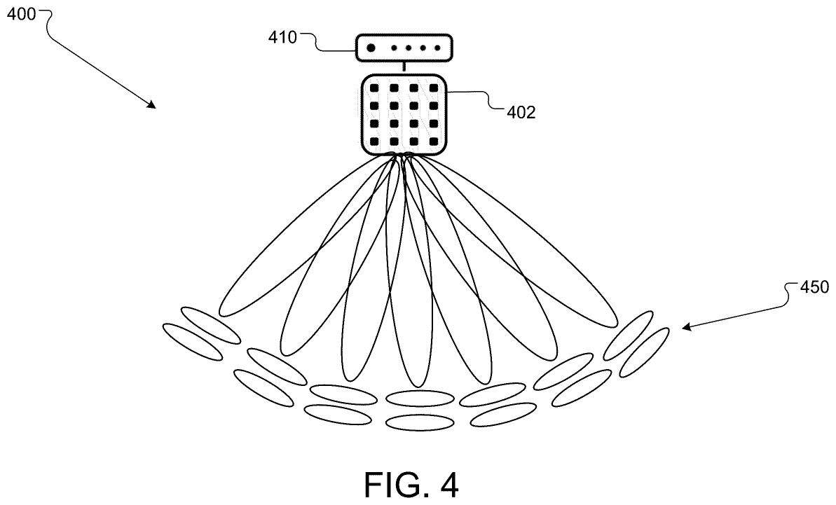

FIG. 4 is a block diagram of an exemplary anchor wireless device 410 configured for beamforming in vertical and azimuthal directions according to some embodiments. In some embodiments, the anchor wireless device 410 is the anchor wireless device 110, 310A, or 310B discussed previously, and is coupled to an array of antennas 402. In some embodiments, the anchor wireless device 310A is further to scan, via the array of antennas 402 with the first wireless signal, at the different time periods, also in a vertical direction (e.g., in addition to an azimuthal direction) to activate ID tags in horizontal slices within a three-dimensional region being scanned. Each slice may be an arbitrarily thin cross-section of the directed beams, and multiple horizontal slices 450 are identified in FIG. 4 by way of example. Although the array of antennas 402 appear to be vertically oriented, this is for simplicity of illustration, and may be understood to be oriented horizontally. In this way, for example, a specific crate of flowers or boxes of products may be located within a massive warehouse despite being stacked within other crates of flowers (or products).

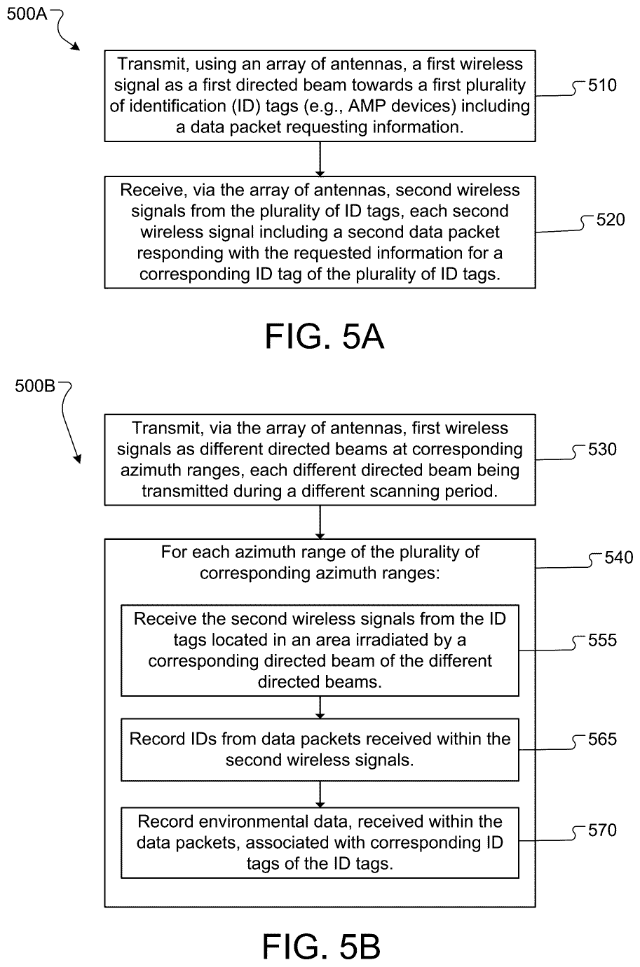

FIG. 5A is a flow diagram of a method 500A of employing beamforming by an anchor wireless device to communicate with a subset of AMP devices according to at least one embodiment of a high-density concentration of AMP devices. The method 500A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500A is performed by the wireless network 100A, 100B, 300, or 400 or an associated system or an anchor wireless device such as the anchor wireless devices 110, 310A, 310B, and/or 410.

At operation 510, an anchor wireless device transmits, using an array of antennas, a first wireless signal as a first directed beam towards a first plurality of identification (ID) tags. In some embodiments, the first plurality of ID tags are ambient power (AMP) devices that harvests environmental energy and the first wireless signal includes a data packet requesting information.

At operation 520, the anchor wireless device receives, via the array of antennas, second wireless signals from the plurality of ID tags. In some embodiments, each second wireless signal includes a second data packet responding with the requested information for a corresponding ID tag of the plurality of ID tags.

FIG. 5B is a flow diagram of a method 500B of scanning, using beamforming, at different azimuth ranges to communicate with multiple subsets of AMP device according to at least another embodiment of a high-density concentration of AMP devices. The method 500B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500B is performed by the wireless network 100A, 100B, 300, or 400 or an associated system or an anchor wireless device such as the anchor wireless devices 110, 310A, 310B, and/or 410. In some embodiments, the method 500B may be viewed as an extension to the method 500A of FIG. 5A.

At operation 530, the anchor wireless device transmits, via the array of antennas, a plurality of first wireless signals as different directed beams at a plurality of corresponding azimuth ranges, each different directed beam being transmitted during a different scanning period.

At operation 540, the anchor wireless device performs additional, sub-operations 555, 565, and 575, for each azimuth range of the plurality of corresponding azimuth ranges. For example, at operation 555, the anchor wireless device receives the second wireless signals from the plurality of ID tags located in an area irradiated by a corresponding directed beam of the different directed beams. At operation 565, the anchor wireless device stores IDs from data packets received within the second wireless signals, e.g., within the data store 105. At operation 575, the anchor wireless device stores environmental data, received within the data packets, associated with corresponding ID tags of the plurality of ID tags, e.g., also within the data store 105.

FIG. 6 is a flow diagram of a method 600 of employing beamforming concurrently by two anchor wireless devices to more efficiently scan a larger area of a high-density concentration of AMP devices according to some embodiments. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the wireless network 100A, 100B, 300, or 400 or an associated system or an anchor wireless device such as the anchor wireless devices 110, 310A, 310B, and/or 410.

At operation 610, a first anchor wireless device transmits, using a first array of antennas, a first wireless signal as a first directed beam towards a first plurality of identification (ID) tags. In some embodiments, the first plurality of ID tags are ambient power (AMP) devices that harvest environmental energy and the first wireless signal includes a first data packet requesting information.

At operation 620, the first anchor wireless device receives, via the first array of antennas, second wireless signals from the first plurality of ID tags. In some embodiments, each second wireless signal includes a second data packet responding with the requested information for a corresponding ID tag of the first plurality of ID tags.

At operation 630, a second anchor wireless device transmits, using a second array of antennas, a third wireless signal as a second directed beam towards a second plurality of ID tags that are co-located or otherwise in a vicinity of the first plurality of ID tags. In some embodiments, the second plurality of ID tags are AMP devices that harvest energy and the third wireless signal includes a third data packet requesting information.

At operation 640, the second anchor wireless device receives, via the second array of antennas, second wireless signals from the second plurality of ID tags. In some embodiments, each second wireless signal includes a fourth data packet responding with the requested information for a corresponding ID tag of the second plurality of ID tags.

At operation 650, the first and second anchor wireless devices optionally deconflict a first channel over which the first wireless signal is transmitted from a second channel over which the third wireless signal is transmitted. In some embodiments, the first channel is a first frequency and the second channel is a second frequency.

With reference to method 600, in some embodiments, the first wireless signal is within a first RF band or a continuous waveform (CW) and the third wireless signal is within one of the first RF band or a second RF band. As an extension to the method 600, in some embodiments, the first and second anchor wireless devices scan a geographic area to identify further ID tags while not double-scanning any single zone of a plurality of zones within the geographic area, thus efficiently coordinating scanning efforts. In some embodiments, the method 600 includes performing de-duplication to remove duplicate ID tags from being stored in the data store 105 if the ID tags had already been scanned during the current scanning sequence across varying azimuths of beamforming.

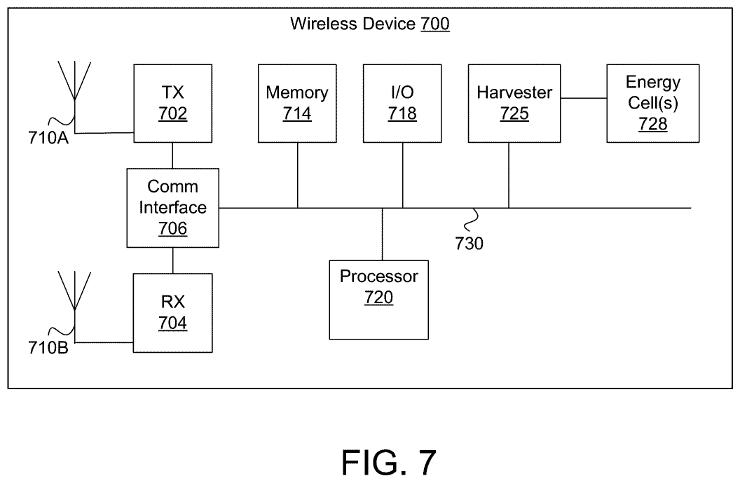

FIG. 7 is a simplified block diagram of an example wireless device 700, which may represent any of the anchor wireless device 110 or client wireless devices discussed herein according to various embodiments. For example, the client wireless devices may include the AMP device 120. In at least some embodiments, the wireless device 700 includes, but is not be limited to, a transmitter 702 or TX (e.g., a WLAN transmitter), a receiver 704 or RX (e.g., a WLAN receiver), a communications interface 706, a TX antenna 710A coupled to the transmitter 702, an RX antenna 710B coupled to the receiver 704, a memory 714, one or more input/output (I/O) devices 718 (such as a display screen, a touch screen, a keypad, and the like), a processor 720, an energy harvester 725, and energy cells 728. These components can all be coupled to a communications bus 730. In some embodiments, aspects of the communication interface 706 work with the processor 720 to perform operations or that function as a processing device of the wireless device 700. In some embodiments, there is a single antenna and multiplexing logic to switch use of the antenna between the TX and RX. In some embodiments, the anchor wireless device 110 has no energy harvester, and instead has a battery and/or is AC-powered.

In at least some embodiments, the memory 714 includes storage to store instructions executable by the processor 720 and/or data generated by the communication interface 706. In various embodiments, frontend components such as the transmitter 702, the receiver 704, the communication interface 706, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-wave™, Zigbee®, LoRa™, Wi-SUN®, or other wireless protocol. While some of the protocols may also be referred to as personal area network (PAN) technology, for simplicity, all are broadly referred to as WLAN technology. Future protocols are also envisioned.

In various embodiments, the communications interface 706 is integrated with the transmitter 702 and the receiver 704, e.g., as a frontend of the wireless device 701. The communication interface 706 may coordinate, as directed by the processor 720, to request/receive packets from other wireless devices or those that reflect off of objects. The communications interface 706 can further process data symbols received by the receiver 704 in a way that the processor 720 can perform further processing, including identifying and parsing data packets received within the wireless signals.

In various embodiments, the energy harvester 725 performs operations disclosed herein to capture electromagnetic or RF signals and other types of non-RF energy, e.g., light, temperature gradients, pressure differential, mechanical vibrations, wind energy, and the like, which were discussed with referenced to FIGS. 1A-1B. As discussed, the energy harvester 725, with reference to harvesting energy from RF wireless signals, may be a multi-band harvester in being configured to harvest energy from multiple ranges of frequencies that define different RF bands. In these embodiments, the energy harvester 725 is also configured to store the harvested energy within the energy cells 728, which then operate as a power source for the wireless device 700.

It will be apparent to one skilled in the art that at least some embodiments may be practiced without these specific details. In other instances, well-known components, elements, or methods are not described in detail or are presented in a simple block diagram format to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A system comprising:
an array of antennas that are controllable to generate directed beams of radio frequency (RF) radiation; and
an anchor wireless device coupled to the array of antennas, the anchor wireless device to:
transmit, via the array of antennas, a first wireless signal as a first directed beam at a first azimuth towards a first plurality of identification (ID) tags, wherein the first plurality of ID tags are ambient power (AMP) devices that harvest environmental energy, and wherein the first wireless signal includes a data packet requesting information; and
receive, via the array of antennas, second wireless signals from the plurality of ID tags, each second wireless signal including a second data packet responding with the requested information for a corresponding ID tag of the plurality of ID tags.

2. The system of claim 1, further comprising the plurality of ID tags, wherein each ID tag of the plurality of ID tags is to:
receive the first wireless signal;
parse the data packet to determine the requested information; and
generate a second wireless signal with the second data packet containing the requested information.

3. The system of claim 2, further comprising an environmental sensor coupled to each of the plurality of ID tags, and wherein the requested information comprises at least one of an ID of a respective ID tag, temperature data, humidity data, pressure data, level data, or environmental-related data received from a respective environmental sensor coupled to the respective ID tag.

4. The system of claim 1, wherein the anchor wireless device is further to:
transmit, via the array of antennas, a plurality of first wireless signals as different directed beams at a plurality of corresponding azimuth ranges, each different directed beam being transmitted during a different scanning period; and
for each azimuth range of the plurality of corresponding azimuth ranges:
receive the second wireless signals from the plurality of ID tags located in an area activated by a corresponding directed beam of the different directed beams;
store IDs from data packets received within the second wireless signals; and
store environmental data, received within the data packets, associated with corresponding ID tags of the plurality of ID tags.

5. The system of claim 4, wherein the anchor wireless device is further to:
assign a beam index to each azimuth range of the plurality of corresponding azimuth ranges;
map, within a data store, each of a plurality of geographic zones to a corresponding beam index; and
store, in the data store, IDs of each of the plurality of ID tags in association with a mapping between a geographic zone and a beam index.

6. The system of claim 4, wherein the anchor wireless device is further to scan, via the array of antennas with the first wireless signal, at different time periods, also in a vertical direction to communicate with ID tags in horizontal slices of a three-dimensional region being scanned.

7. The system of claim 1, wherein the anchor wireless device is further to one of:
transmit an energizing RF signal towards the plurality of ID tags from which the plurality of ID tags harvest energy; or
cause the first wireless signal to also be the energizing RF signal.

8. The system of claim 7, wherein the energizing RF signal is a millimeter wave signal.

9. The system of claim 7, wherein the first wireless signal is within a first RF band or is a continuous waveform (CW), and wherein each second wireless signal is within one of the first RF band or a second RF band.

10. A method comprising:
transmitting, by an anchor wireless device using an array of antennas, a first wireless signal as a first directed beam towards a first plurality of identification (ID) tags, wherein the first plurality of ID tags are ambient power (AMP) devices that harvest environmental energy, and wherein the first wireless signal includes a data packet requesting information; and
receiving, via the array of antennas, second wireless signals from the plurality of ID tags, each second wireless signal including a second data packet responding with the requested information for a corresponding ID tag of the plurality of ID tags.

11. The method of claim 10, further comprising:
receiving, by each ID tag of the plurality of ID tags, the first wireless signal;
parsing, by each ID tag, the data packet to determine the requested information; and
generating, by each ID tag, a second wireless signal with the second data packet containing the requested information.

12. The method of claim 10, wherein the requested information comprises at least one of an ID of a respective ID tag, temperature data, pressure data, or environmental-related data received from a respective environmental sensor coupled to a respective ID tag of the plurality of ID tags.

13. The method of claim 10, further comprising:
transmitting, via the array of antennas, a plurality of first wireless signals as different directed beams at a plurality of corresponding azimuth ranges, each different directed beam being transmitted during a different scanning period; and
for each azimuth range of the plurality of corresponding azimuth ranges:
receiving the second wireless signals from the plurality of ID tags located in an area activated by a corresponding directed beam of the different directed beams;
storing IDs from data packets received within the second wireless signals; and
storing environmental data, received within the data packets, associated with corresponding ID tags of the plurality of ID tags.

14. The method of claim 13, further comprising:
assign a beam index to each azimuth range of the plurality of corresponding azimuth ranges;
map, within a data store, each of a plurality of geographic zones to a corresponding beam index; and
store, in the data store, IDs of each of the plurality of ID tags in association with a mapping between a geographic zone and a beam index.

15. The method of claim 13, further comprising scanning, via the array of antennas with the first wireless signal, at different time periods, also in a vertical direction to communicate with ID tags in horizontal slices of a three-dimensional region being scanned.

16. The method of claim 10, further comprising one of:
transmitting, by the anchor wireless device, an energizing RF signal towards the plurality of ID tags from which the plurality of ID tags harvest energy; or
causing, by the anchor wireless device, the first wireless signal to also be the energizing RF signal.

17. The method of claim 16, wherein the energizing RF signal is a millimeter wave signal.

18. The method of claim 16, wherein the first wireless signal is within a first RF band or is a continuous waveform (CW), and wherein each second wireless signal is within one of the first RF band or a second RF band.

19. A method comprising:
transmitting, by a first anchor wireless device using a first array of antennas, a first wireless signal as a first directed beam towards a first plurality of identification (ID) tags, wherein the first plurality of ID tags are ambient power (AMP) devices that harvest environmental energy, and wherein the first wireless signal includes a first data packet requesting information;
receiving, via the first array of antennas, second wireless signals from the first plurality of ID tags, each second wireless signal including a second data packet responding with the requested information for a corresponding ID tag of the first plurality of ID tags;
transmitting, by a second anchor wireless device using a second array of antennas, a third wireless signal as a second directed beam towards a second plurality of ID tags that are co-located in a vicinity of the first plurality of ID tags, wherein the second plurality of ID tags are AMP devices that harvest energy, and wherein the third wireless signal includes a third data packet requesting information; and
receiving, via the second array of antennas, second wireless signals from the second plurality of ID tags, each second wireless signal including a fourth data packet responding with the requested information for a corresponding ID tag of the second plurality of ID tags.

20. The method of claim 19, deconflicting, by the first and second anchor wireless devices, a first channel over which the first wireless signal is transmitted from a second channel over which the third wireless signal is transmitted.

21. The method of claim 19, wherein the first wireless signal is within a first RF band or is a continuous waveform (CW) and the third wireless signal is within one of the first RF band or a second RF band, further comprising scanning a geographic area, by the first and second anchor wireless devices, to identify further ID tags while not double-scanning any single zone of a plurality of zones within the geographic area.
